(19) United States
(12) Patent Application Publication
(10) Pub. No.: US 2024/0351946 A1
(43) Pub. Date: Oct. 24, 2024

(54) CONSTRUCTION MATERIAL COMPOSITIONS HAVING HIGH EARLY AND LATE STRENGTH

(71) Applicant: BASF SE, Ludwigshafen am Rhein (DE)

(72) Inventors: Harald GRASSL, Trostberg (DE); Joachim DENGLER, Trostberg (DE); Roswitha MUSSNER, Trostberg (DE); Zsolt SZENTMIKLOSI, Trostberg (DE)

(21) Appl. No.: 18/685,532

(22) PCT Filed: Aug. 9, 2022
(86) PCT No.: PCT/EP2022/072301

§ 371 Date: Feb. 22, 2024

(30) Foreign Application Priority Data
Aug. 25, 2021 (EP) 21193080.5

(51) Int. Cl. C04B 7/04; C04B 24/02; C04B 28/04; C04B 103/00; C04B 103/40

(52) U.S. Cl. CPC C04B 7/04; C04B 24/02; C04B 28/04; C04B 2103/0006; C04B 2103/408

(57) ABSTRACT

The present invention relates to a binder composition comprising Portland cement clinker, calcium sulfate, an inorganic sulfate source having a solubility higher than 100 g/l at 20° C. polyalcohol and/or metal salts thereof, a carbonate selected of the group consisting of organic carbonate, alkali carbonate, and mixtures thereof, a component F), and dispersant having a charge density of more than 0.80 μeq/g.

The present invention relates to a binder composition comprising Portland cement clinker, calcium sulfate, an inorganic sulfate source having a solubility higher than 100 g/l at 20° C., polyalcohol and/or metal salts thereof, a carbonate selected of the group consisting of organic carbonate, alkali carbonate, and mixtures thereof, a component F), and dispersant having a charge density of more than 0.80 μeq/g.

Mortar and cement are formulations based on Portland cement clinker. Such cementitious systems are more often under observation in view of environmental aspects due to CO2 emission. The trend in the cement industry to cope with the CO₂ emission is to use more supplementary cementitious materials such as limestone, slag, fly ash, and recently newly developed calcined clays, in the ordinary Portland cement (OPC) (Scrivener et al., Cement and Concrete Research, 114, 2018).

The general draw back of the use of high amount of supplementary cementitious materials in the cement is the relatively low early strength. In systems incorporated with calcined clay and limestone (so called LC³ cement, using ˜50% of OPC), the performance of the cement is comparable with the OPC in many aspects such as long-term strength (Antoni et al., Cement and Concrete Research, 42, 2012) and durability (Scrivener et al., Advances in Civil Engineering Materials, 8, 2019). However, the early strength is relatively low compared to the OPC due to the reduced amount of the C₃S coming from the OPC which contributes to the early strength.

It is known in the art that additives may be added to aqueous slurries or powder dispersants for improving the early strength. Such additive may however effect the workability, i.e. kneadability, spreadybility, sprayability, pumpability, or flowability. Hence, further additives are needed in order to provide a sufficient workability. Such admixtures are capable of preventing the formation of solid agglomerates and of dispersing the particles already present and those newly formed by hydration and in this way improving the workability. This effect is utilized in the preparation of construction material compositions which contain e.g. hydraulic binders, such as cement, lime, gypsum, hemihydrate or anhydrite. For example, set control agents or retarders may be used as additives to delay the hydration reaction and improve the workability. The retarders delay the hydration on-set by inhibiting the dissolution of the reactive cement components, in particular aluminates, and/or by masking the calcium ions thereby slowing down the hydration reaction. DE 42 17 181 A1 discloses condensation products of melamine and glyoxylic acids as additives for hydraulic binders.

WO2016206780 describes an additive that accelerates the development of strength of hydraulic binders comprising a specific alkanolamine. It remains however unclear whether workability is affected.

Against the background, it has been an object of the present invention to provide a binder composition that provides high early and/or late strength having sufficient workability. It has further been an object of the present invention to provide a construction material composition with a reduced CO₂ profile. It has also been an object of the present invention to provide a binder composition having a reduced amount of Portland cement clinker, which provides a comparable early and/or late strength compared to OPC with higher amount of Portland cement clinker.

It has surprisingly been found that the above objects can be achieved by the binder composition comprising specific additive components as claimed. It has further been found that the herein described particular retarding mixture and a dispersant having a charge density of more than 0.80 μeq/g can be used to improving the spread and/or the compressive strength of a construction material composition, for retarding the hardening of inorganic binder containing building material formulations and/or for producing building products.

In a first aspect, the present invention therefore relates to a binder composition comprising
A) Portland cement clinker in an amount of 25 to 94.089 wt.-%;
B) calcium sulfate x H₂O in an amount of 5 to 20 wt.-%, wherein x is selected from 0 to 2;
C) an inorganic sulfate source having a solubility higher than 100 g/l at 20° C. in an amount of 0.3 to 10 wt.-%;
D) polyalcohol and/or metal salts thereof in an amount of 0.2 to 5 wt.-%;
E) a carbonate selected of the group consisting of organic carbonate, alkali carbonate, and mixtures thereof, in an amount of 0.3 to 5 wt.-%;
F) a component F) selected from the group consisting of a compound of formula (I), a polycondensate of said compound of formula (I), and mixtures thereof, wherein formula (I) is represented by

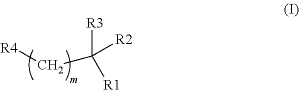

wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH(OH)—SO₃X;
R3 is H, COOX, C₃-C₆ alkyl which may be substituted by 1 to 6 OH or C₁-C₆ alkoxy;
m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and
Z is CH₂ or CH (OH), in an amount of 0.101 to 3.5 wt.-%; and
G) dispersant having a charge density of more than 0.80 μeq/g in an amount of 0.01 to 1 wt.-%;

each based on the total weight of the binder composition.

In the following, preferred embodiments of the components of the of the binder composition are described in further detail. It is to be understood that each preferred embodiment is relevant on its own as well as in combination with other preferred embodiments.

In a preferred embodiment A1 of the first aspect, the polyalcohol (and/or metal salts thereof) is selected from the group consisting of i) NR¹R²R³, wherein R¹ to R³ are independently C₁-C₆-hydroxyalkyl, (CH₂O)ₙ—OH, (CH₂CH₂O)ₙ—OH, (CH₂CH₂CH₂O)ₙ—OH, (CHOH)ₙ—C(═O)H, or (CHOH)ₙ—CH₂OH, wherein n is an integer from 1 to 10; ii) R⁵—(CHOH)ₒ—R⁴, wherein R⁴ and R⁵ are independently C₁-C₆-hydroxyalkyl, C₂-C₆-hydroxyalkenyl, C₁-C₆-aminoalkyl, —OH, C₁-C₅-alkyl, C(═O)H, or C(═O)OH, wherein o is an integer from 0-5; and mixtures thereof, preferably wherein the polyalcohol (and/or metal salts thereof) is a mixture of i) NR¹R²R³ and ii) R⁵—(CHOH)ₒ—R⁴.

In a preferred embodiment A2 of the first aspect, the polyalcohol (and/or metal salts thereof) is selected from the group consisting of i) NR¹R²R³, wherein R¹ to R³ are independently C₁-C₆-hydroxyalkyl; ii) R⁵—(CHOH)ₒ—R⁴, wherein R⁴ and R⁵ are independently C₁-C₆-hydroxyalkyl, wherein o is an integer from 0-1; and mixtures thereof, preferably wherein the polyalcohol (and/or metal salts thereof) is a mixture of i) NR¹R²R³, wherein R¹ to R³ are C₂-C₃-hydroxyalkyl and ii) R⁵—(CHOH)ₙ—R⁴, wherein R⁴ and R⁵ are independently C₁-C₂-hydroxyalkyl, wherein o is an integer from 0-1, and in particular wherein the polyalcohol (and/or metal salts thereof) is a mixture of i) triethanolamine and ii) glycerol or a mixture of i) triethanolamine calcium salt and ii) calcium glycerolate.

In a preferred embodiment A3 of the first aspect, the carbonate is an alkali carbonate selected from the group consisting of sodium carbonate, sodium bicarbonate, potassium carbonate, potassium bicarbonate, lithium carbonate, lithium bicarbonate, and mixtures thereof, preferably sodium bicarbonate.

In a preferred embodiment A4 of the first aspect, the inorganic sulfate source is an alkali sulfate selected from the group consisting of potassium sulfate, sodium sulfate, lithium sulfate, and mixtures thereof, preferably sodium sulfate and/or wherein the calcium sulfate is calcium sulfate anhydride.

In a preferred embodiment A5 of the first aspect, the dispersant has a charge density of more than 1.20 μeq/g, preferably of more than 1.2 to 14 μeq/g, more preferably of 1.5 to 10.0 peq/g, and in particular of 2.0 to 5.0 μeq/g.

In a preferred embodiment A6 of the first aspect, the dispersant is a comb polymer comprising units having acid functions having at least one structural unit of the general formulae (Ia), (Ib), (Ic) and/or (Id):

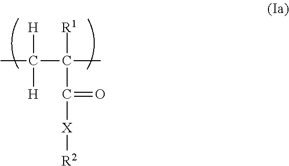

in which

R¹ is H or an unbranched or branched C₁-C₄ alkyl group, CH₂COOH or CH₂CO—X—R², preferably H or CH₃;

X is NH—(CₙH₂ₙ), O(CₙH₂ₙ) with n=1, 2, 3 or 4, where the nitrogen atom or the oxygen atom is bonded to the CO group, or is a chemical bond, preferably X is chemical bond or O(CₙH₂ₙ);

R² is OM, PO₃M₂, or O—PO₃M₂, with the proviso that X is a chemical bond if R² is OM;

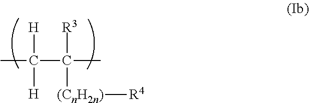

in which

R³ is H or an unbranched or branched C₁-C₄ alkyl group, preferably H or CH₃;

n is 0, 1, 2, 3 or 4, preferably 0 or 1;

R⁴ is PO₃M₂, or O—PO₃M₂;

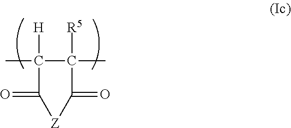

in which

R⁵ is H or an unbranched or branched C₁-C₄ alkyl group, preferably H;

Z is O or NR⁷, preferably O;

R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂, and

n is 1, 2, 3 or 4, preferably 1, 2 or 3;

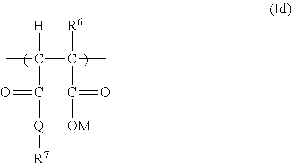

in which

R⁶ is H or an unbranched or branched C₁-C₄ alkyl group, preferably H;

Q is NR⁷ or O, preferably O;

R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂,

n is 1, 2, 3 or 4, preferably 1, 2 or 3; and

each M independently of any other is H or a cation equivalent and/or the dispersant is a comb polymer comprising units having a polyether side chain having at least one structural unit of the general formulae (IIa), (IIb), (IIc) and/or (IId):

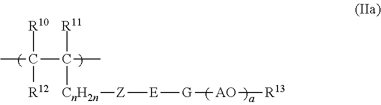

in which

R¹⁰, R¹¹ and R¹² independently of one another are H or an unbranched or branched C₁-C₄ alkyl group;

Z is O or S;

E is an unbranched or branched C₁-C₆ alkylene group, a cyclohexylene group, CH₂-C₆H₁₀, 1,2-phenylene, 1,3-phenylene or 1,4-phenylene;

G is O, NH or CO—NH; or

E and G together are a chemical bond;

A is CₓH₂ₓ with x=2, 3, 4 or 5, preferably 2 or 3, or is CH₂CH (C₆H₅);

n is 0, 1, 2, 3, 4 or 5, preferably 0, 1 or 2;

a is an integer from 2 to 350, preferably 5 to 150, more preferably 20-135, most preferred 60-135;

R¹³ is H, an unbranched or branched C₁-C₄ alkyl group, CO—NH₂ and/or COCH₃;

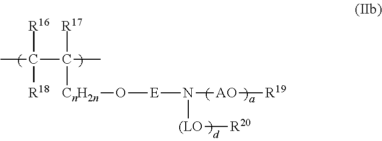

in which

R¹⁶, R¹⁷ and R¹⁸ independently of one another are H or an unbranched or branched C₁-C₄ alkyl group;

E is an unbranched or branched C₁-C₆ alkylene group, a cyclohexylene group, CH₂-C₆H₁₀, 1,2-phenylene, 1,3-phenylene, or 1,4-phenylene, or is a chemical bond;

A is CₓH₂ₓ with x=2, 3, 4 or 5, preferably 2 or 3, or is CH₂CH (C₆H₅);

n is 0, 1, 2, 3, 4 and/or 5, preferably 0, 1 or 2;

L is CₓH₂ₓ with x=2, 3, 4 or 5, preferably 2 or 3, or is CH₂—CH (C₆H₅);

a is an integer from 2 to 350, preferably 5 to 150;

d is an integer from 1 to 350, preferably 5 to 150;

R¹⁹ is H or an unbranched or branched C₁-C₄ alkyl group;

R²⁰ is H or an unbranched C₁-C₄ alkyl group;

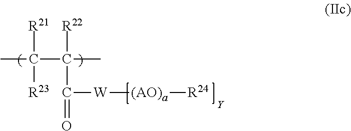

in which

R²¹, R²² and R²³ independently of one another are H or an unbranched or branched C₁-C₄ alkyl group;

W is O, NR²⁵, or is N;

Y is 1 if W=O or NR²⁵, and is 2 if W=N;

A is CₓH₂ₓ with x=2, 3, 4 or 5, preferably 2 or 3, or is CH₂CH (C₆H₅);

a is an integer from 2 to 350, preferably 5 to 150, more preferably 20-135, most preferred 60-135;

R²⁴ is H or an unbranched or branched C₁-C₄ alkyl group; and

R²⁵ is H or an unbranched or branched C₁-C₄ alkyl group;

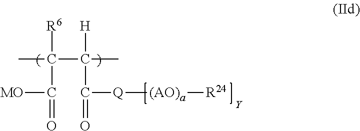

in which

R⁶ is H or an unbranched or branched C₁-C₄ alkyl group;

Q is NR¹⁰, N or O;

Y is 1 if W=O or NR¹⁰ and is 2 if W=N;

R¹⁰ is H or an unbranched or branched C₁-C₄ alkyl group; and

A is CₓH₂ₓ with x=2, 3, 4 or 5, preferably 2 or 3, or is CH₂C (C₆H₅) H;

R²⁴ is H or an unbranched or branched C₁-C₄ alkyl group;

M is H or a cation equivalent; and

a is an integer from 2 to 350, preferably 5 to 150, more preferably 20-135, most preferred 60-135.

In a preferred embodiment A7 of the first aspect, the dispersant is a phosphorylated polycondensation product comprising structural units (III) and (IV):

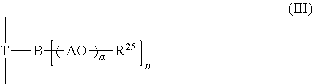

in which
T is a substituted or unsubstituted phenyl or naphthyl radical or a substituted or unsubstituted heteroaromatic radical having 5 to 10 ring atoms, of which 1 or 2 atoms are heteroatoms selected from N, O and S;
n is 1 or 2;
B is N, NH or O, with the proviso that n is 2 if B is N and with the proviso that n is 1 if B is NH or O;
A is an unbranched or branched alkylene with 2 to 5 carbon atoms or CH₂CH (C₆H₅);
a is an integer from 1 to 300;
R²⁵ is H, a branched or unbranched C₁ to C₁₀ alkyl radical, C₅ to C₈ cycloalkyl radical, aryl radical, or heteroaryl radical having 5 to 10 ring atoms, of which 1 or 2 atoms are heteroatoms selected from N, O and S;
where the structural unit (IV) is selected from the structural units (IVa) and (IVb):

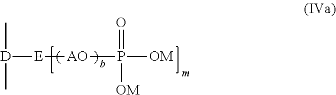

in which
D is a substituted or unsubstituted phenyl or naphthyl radical or a substituted or unsubstituted heteroaromatic radical having 5 to 10 ring atoms, of which 1 or 2 atoms are heteroatoms selected from N, O and S;
E is N, NH or O, with the proviso that m is 2 if E is N and with the proviso that m is 1 if E is NH or O;
A is an unbranched or branched alkylene with 2 to 5 carbon atoms or CH₂CH (C₆H₅);
b is an integer from 0 to 300;
M independently at each occurrence is H or a cation equivalent;

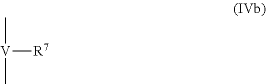

in which
V is a substituted or unsubstituted phenyl or naphthyl radical and is optionally substituted by 1 or two radicals selected from R⁸, OH, OR⁸, (CO) R⁸, COOM, COOR⁸, SO₃R⁸ and NO₂;
R⁷ is COOM, OCH₂COOM, SO₃M or OPO₃M₂;
M is H or a cation equivalent; and

R⁸ is C₁-C₄ alkyl, phenyl, naphthyl, phenyl-C₁-C₄ alkyl or C₁-C₄ alkylphenyl.

In a preferred embodiment A8 of the first aspect, the component F) comprises hydroxycarboxylic acid or the polycondensate of said hydroxycarboxylic acid or the sulfite addition product of said hydroxycarboxylic acid or citric acid or tartaric acid, preferably wherein the hydroxycarboxylic acid or the polycondensate of said hydroxycarboxylic acid or the sulfite addition product of said hydroxycarboxylic acid is glyoxylic acid or a polycondensate of glyoxylic acid or a sulfite addition product of glyoxylic acid, more preferably wherein the polycondensate of glyoxylic acid is an amine-glyoxylic acid condensate, even more preferably wherein the amine-glyoxylic acid condensate is selected from the group consisting of a melamine-glyoxylic acid condensate, a urea-glyoxylic acid condensate, a melamine-urea-glyoxylic acid condensate, and a polyacrylamide-glyoxylic acid condensate, in particular urea-glyoxylic acid condensate.

In a preferred embodiment A9 of the first aspect, the component F) comprises a salt of formula (I) having the following moieties

R2 is H,

R3 is C₃-C₆ alkyl which may be substituted by 1 to 5 OH, and

R4 is COOY, and

Y is X being an alkali metal, preferably wherein the salt is sodium gluconate

In a preferred embodiment A10 of the first aspect, the component F) comprises at least two compounds selected from the group consisting of a compound of formula (I) and a polycondensate of said compound of formula (I), preferably wherein component F) comprises a mixture of a compound of formula (I) and a polycondensate of said compound of formula (I), more preferably wherein the component F) comprises a polycondensate of glyoxylic acid and a salt of formula (I) having the following moieties

R2 is H,

R3 is C₃-C₆ alkyl which may be substituted by 1 to 5 OH, and

R4 is COOY, and

Y is X being an alkali metal, preferably wherein the salt is sodium gluconate.

In a preferred embodiment A11 of the first aspect, the binder composition further comprises

H) a supplementary cementitious material in an amount of from 0.5 to 68.989 wt.-%, based on the total weight of the binder composition, preferably wherein the supplementary cementitious material is selected from the group consisting of slag, fly ash, natural pozzolans, calcinated clay, silica fume, limestone, and mixtures thereof, preferably limestone.

In a second aspect, the present invention relates to the use of a retarding mixture (RM) comprising

RM1) a carbonate selected from the group consisting of organic carbonate, alkali carbonate, and mixtures thereof, in an amount of from 30 to 60 wt.-%;

RM2) NR¹R²R³ and/or metal salts thereof, wherein R¹ to R³ are independently C₁-C₆-hydroxyalkyl, in an amount of from 5 to 20 wt.-%;

RM3) R⁵-(CHOH)ₒ-R⁴ and/or metal salts thereof, wherein R⁴ and R⁵ are independently C₁-C₆-hydroxyalkyl, wherein o is an integer from 0-1, in an amount of from 10 to 30 wt.-%;

RM4) a component RM4) selected from the group consisting of a compound of formula (I), a polycondensate of said compound of formula (I), and mixtures thereof, wherein formula (I) is represented by

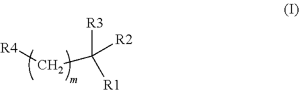

wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH (OH)—SO₃X;
R3 is H, COOX, C₃-C₆ alkyl which may be substituted by 1 to 6 OH or C₁-C₆ alkoxy;
m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and

Z is CH₂ or CH (OH), in an amount of from 12 to 50 wt.-%;

each based on the total weight of the retarding mixture (RM),

and a dispersant having a charge density of more than 0.80 μeq/g for improving the spread and/or the compressive strength of a construction material composition comprising Portland cement clinker, calcium sulfate, sodium sulfate, and optionally supplementary cementitious material.

In a third aspect, the present invention relates to a concrete comprising the binder composition according to the first aspect.

In a fourth aspect, the present invention relates to the use of a retarding mixture (RM) comprising

RM1) a carbonate selected from the group consisting of organic carbonate, alkali carbonate, and mixtures thereof, in an amount of from 30 to 60 wt.-%;

RM2) NR¹R²R³ and/or metal salts thereof, wherein R¹ to R³ are independently C₁-C₆-hydroxyalkyl, in an amount of from 5 to 20 wt.-%;

RM3) R⁵—(CHOH)ₒ—R⁴ and/or metal salts thereof, wherein R⁴ and R⁵ are independently C₁-C₆-hydroxyalkyl, wherein o is an integer from 0-1, in an amount of from 10 to 30 wt.-%;

RM4) a component RM4) selected from the group consisting of a compound of formula (I), a polycondensate of said compound of formula (I), and mixtures thereof, wherein formula (I) is represented by

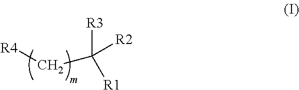

wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH (OH)—SO₃X;
R3 is H, COOX, C₃-C₆ alkyl which may be substituted by 1 to 6 OH or C₁-C₆ alkoxy; m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and

Z is CH₂ or CH (OH),

in an amount of from 12 to 50 wt.-%;

each based on the total weight of the retarding mixture (RM),

and a dispersant having a charge density of more than 0.80 μeq/g for retarding the hardening of inorganic binder containing building material formulations and/or for producing building products.

### DETAILED DESCRIPTION

Before describing in detail exemplary embodiments of the present invention, definitions important for understanding the present invention are given.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%. It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “il” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

The term “substituted”, as used herein, means that a hydrogen atom bonded to a designated atom is replaced with a specified substituent, provided that the substitution results in a stable or chemically feasible compound. Unless otherwise indicated, a substituted atom may have one or more substituents and each substituent is independently selected.

The term “substitutable”, when used in reference to a designated atom, means that attached to the atom is a hydrogen, which can be replaced with a suitable substituent.

When it is referred to certain atoms or moieties being substituted with “one or more” substituents, the term “one or more” is intended to cover at least one substituent, e.g. 1 to 10 substituents, preferably 1, 2, 3, 4, or 5 substituents, more preferably 1, 2, or 3 substituents, most preferably 1, or 2 substituents. When neither the term “unsubstituted” nor “substituted” is explicitly mentioned concerning a moiety, said moiety is to be considered as unsubstituted.

The organic moieties mentioned in the above definitions of the variables are-like the term halogen-collective terms for individual listings of the individual group members. The prefix Cₙ-Cₘ indicates in each case the possible number of carbon atoms in the group.

The term “halogen” denotes in each case fluorine, bromine, chlorine or iodine, in particular fluorine, chlorine, or bromine.

The term “alkyl” as used herein denotes in each case a straight-chain or branched alkyl group having usually from 1 to 6 carbon atoms, preferably 1 to 5 or 1 to 4 carbon atoms, more preferably 1 to 3 or 1 or 2 carbon atoms. Examples of an alkyl group are methyl, ethyl, n-propyl, iso-propyl, n-butyl, 2-butyl, iso-butyl, tert-butyl, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, and 1-ethyl-2-methylpropyl.

The term “alkoxy” as used herein denotes in each case a straight-chain or branched alkyl group which is bonded via an oxygen atom and has usually from 1 to 6 carbon atoms, preferably 1 to 2 carbon atoms, more preferably 1 carbon atom. Examples of an alkoxy group are methoxy, ethoxy, n-propoxy, iso-propoxy, n-butyloxy, 2-butyloxy, iso-butyloxy, tert.-butyloxy, and the like.

The term “hydroxyalkyl” as used herein denotes in each case a straight-chain or branched alkyl group having usually from 1 to 6 carbon atoms and being further substituted with 1 to 5, preferably with 1 to 2 hydroxy groups, in particular with 1 hydroxy group. Preferably, the one hydroxy group is terminating the straight-chain or branched alkyl group so that the hydroxy group is bonded to an alkyl bridge, which is bonded to the remainder of the molecule. Examples of an hydroxyalkyl group are hydroxymethyl, hydroxyethyl, n-hydroxypropyl, 2-hydroxypropyl, n-hydroxybutyl, 2-hydroxybutyl, 2-hydroxy-2-methylpropyl, n-hydroxypentyl, and n-hydroxyhexyl. Hydroxymethyl, hydroxyethyl, hydroxypropyl, and hydroxybutyl, are preferred, in particular hydroxyethyl.

The term “hydroxyalkenyl” as used herein denotes in each case an unsaturated hydrocarbon group having usually 2 to 6, preferably 2 to 4 carbon atoms comprising at least one carbon-carbon double bond in any position and being further substituted with 1 to 5, preferably with 1 to 2 hydroxy groups, in particular with 1 hydroxy group. Preferably, the one hydroxy group is terminating the unsaturated hydrocarbon group so that the hydroxy group is bonded to an alkenyl bridge, which is bonded to the remainder of the molecule. Examples of an hydroxyalkenyl are hydroxyvinyl, hydroxyallyl, hydroxymethallyl, hydroxybuten-1-yl, 2-hydroxy-2-penten-1-yl, 1-hydroxy-3-penten-1-yl and the like. If geometric isomers are possible with regard to the double bond, the present invention relates to both, the E-and Z-isomers.

The term “aminoalkyl” as used herein denotes in each case a straight-chain or branched alkyl group having usually from 1 to 6 carbon atoms and being further substituted with 1 to 5, preferably with 1 to 2 amino groups, in particular 1 amino group. Preferably, the one amino group is terminating the straight-chain or branched alkyl group so that the amino group is bonded to an alkyl bridge, which is bonded to the remainder of the molecule. Examples of an aminoalkyl group are aminomethyl, aminoethyl, n-aminopropyl, 2-aminopropyl, n-aminobutyl, 2-aminobutyl, 2-amino-2-methylpropyl, n-aminopentyl, and n-aminohexyl. Aminomethyl, aminoethyl, aminopropyl, and aminobutyl, are preferred, in particular aminoethyl.

When referring to compositions and the weight percent of the therein comprised ingredients it is to be understood that according to the present invention the overall amount of ingredients does not exceed 100% (+1% due to rounding).

The mineralogical phases are indicated by their usual name followed by their cement notation.

The primary compounds are represented in the cement notation by the oxide varieties: C for CaO, S for SiO₂, A for Al₂O₃, $ for SO₃, H for H₂O; this notation is used throughout.

The term “Portland cement” generally denotes any cement compound containing Portland clinker, especially CEM I, II, III, IV and V within the meaning of standard EN 197-1, paragraph 5.2. An exemplary cement is ordinary Portland cement (OPC) according to DIN EN 197-1 which may either contain calcium sulfate (<7% by weight) or is essentially free of calcium sulfate (<1% by weight).

Calcium aluminate cement (also referred to as CAC or high aluminate cement) means a cement containing calcium aluminate phases. The term “aluminate phase” denotes any mineralogical phase resulting from the combination of aluminate (of chemical formula Al₂O₃, or “A” in cement notation), with other mineral species. The amount of alumina (in form of Al₂O₃) is at least 2 wt.-%, preferably at least 3 wt.-%, and more preferably at least 4 wt.-%, of the total mass of the aluminate-containing cement as determined by means of X-ray fluorescence (XRF). More precisely, said mineralogical phase of aluminate type comprises e.g. tricalcium aluminate (C₃A), monocalcium aluminate (CA), calcium-di-aluminate (CA2), mayenite (C₁₂A₇), gehlenite (C2AS), tetracalcium aluminoferrite (C₄AF), or a combination of several of these phases.

Sulfoaluminate cement has a content of yeelimite (of chemical formula 4CaO.3Al₂O₃.SO₃ or C₄A₃$ in cement notation) of greater than 15% by weight.

Mineralogical phases in cement are typically determined using quantitative X-ray diffraction (XRD).

As used herein the term “construction material composition” denotes a composition comprising a binder composition and aggregates such as sand.

As used herein the term “binder composition” denotes a composition comprising a binder such as Portland cement. The binder composition according to the present invention comprises fine granulates, i.e. granulates whose diameter is less than 0.125 mm.

As indicated above, the present invention relates in one embodiment to a binder composition comprising

A) Portland cement clinker in an amount of 25 to 94.089 wt.-%;

B) calcium sulfate x H₂O in an amount of 5 to 20 wt.-%, wherein x is an selected from 0 to 2;

C) an inorganic sulfate source having a solubility higher than 100 g/l at 20° C. in an amount of 0.3 to 10 wt.-%;

D) polyalcohol and/or metal salts thereof in an amount of 0.2 to 5 wt.-%;

E) a carbonate selected of the group consisting of organic carbonate, alkali carbonate, and mixtures thereof, in an amount of 0.3 to 5 wt.-%;

F) a component F) selected from the group consisting of a compound of formula (I), a polycondensate of said compound of formula (I), and mixtures thereof, wherein formula (I) is represented by

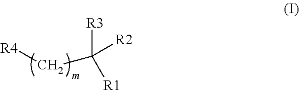

wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH (OH)—SO₃X;
R3 is H, COOX, C₃-C₆ alkyl which may be substituted by 1 to 6, preferably 1 to 5, OH or C₁-C₆ alkoxy;
m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and
Z is CH₂ or CH (OH), in an amount of 0.101 to 3.5 wt.-%; and
G) dispersant having a charge density of more than 0.80 μeq/g in an amount of 0.01 to 1 wt.-%;

each based on the total weight of the binder composition.

In a preferred embodiment, the binder composition comprising

A) Portland cement clinker in an amount of 25 to 94.089 wt.-%;

B) calcium sulfate x H₂O in an amount of 5 to 20 wt.-%, wherein x is an selected from 0 to 2;

C) an inorganic sulfate source having a solubility higher than 100 g/l at 20° C. in an amount of 0.3 to 10 wt.-%;

D) polyalcohol in an amount of 0.2 to 5 wt.-%;

E) a carbonate selected of the group consisting of organic carbonate, alkali carbonate, and mixtures thereof, in an amount of 0.3 to 5 wt.-%;

F) a component F) selected from the group consisting of a compound of formula (I), a polycondensate of said compound of formula (I), and mixtures thereof, wherein formula (I) is represented by

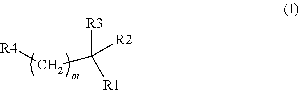

wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH(OH)—SO₃X;
R3 is H, COOX, C₃-C₆ alkyl which may be substituted by 1 to 6, preferably 1 to 5, OH or C₁-C₆ alkoxy;
m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and
Z is CH₂ or CH (OH), in an amount of 0.101 to 3.5 wt.-%; and

G) dispersant having a charge density of more than 0.80 μeq/g in an amount of 0.01 to 1 wt.-%;

each based on the total weight of the binder composition.

Preferably, the charge density of the dispersant is calculated assuming that all acid groups (e.g. sulfonate, phosphate and carboxylate) are fully deprotonated. Charge density p is calculated with

$$ρ = \frac{N ( neg . charges )}{m}$$

(N=number of negative charges; m=total mass of dispersant).

In the following, preferred embodiments of the binder composition and its components, which are relevant for all aspects of the invention, are described in further detail hereinafter. It is to be understood that each preferred embodiment is relevant on its own as well as in combination with other preferred embodiments.

It is to be understood that according to the present invention the term “Portland cement clinker” refers to the sum of clinker phases without any calcium sulfate phase. Portland cement clinker phases are including e.g. alite (C₃S), belite (C₂S), brownmillerite (C₄AF), or C₃A and mixtures thereof.

In a preferred embodiment the Portland cement clinker comprises mainly belite in an amount of more than 40 wt.-%, based on the total weight of the Portland cement clinker.

The clinker bearing material is preferably ordinary Portland cement (OPC) according to DIN EN 197-1:2011-11. Preferred OPC's are according to the norm are CEM I 42.5 N, CEM I 42.5 R, CEM I 52.5 N, and CEM I 52.5 R or mixtures thereof with an amount of at least 90 wt.-%, more preferably at least 92 wt.-%, and in particular at least 94 wt.-%, of Portland cement clinker.

Preferably, the binder composition comprises the Portland cement clinker in an amount of 28 to 90 wt.-%; more preferably of 30 to 80 wt.-%, based on the total weight of the binder composition. In a specific embodiment, the binder composition comprises the Portland cement clinker in an amount of 28 to 93.75 wt.-%; more preferably of 30 to 91.86 wt.-%, based on the total weight of the binder composition.

The Portland cement clinker may be provided by ordinary Portland cement, preferably comprising aluminate types selected from the group consisting of C3A, C4AF, and mixtures thereof.

In a preferred embodiment, the ordinary Portland cement comprises at least 1 wt.-%, more preferably at least 5 wt.-%, and even more preferably at least 10 wt.-%, of aluminate types selected from the group consisting of C3A, C4AF, and mixtures thereof. It is further preferred that the ordinary Portland cement comprises less than 25 wt.-%, more preferably less than 22 wt.-%, and even more preferably less than 20 wt.-%, of aluminate types selected from the group consisting of C3A, C4AF, and mixtures thereof. In a preferred embodiment, the ordinary Portland cement comprises less than 5 wt.-%, more preferably less than 4 wt.-%, and even more preferably less than 3 wt.-%, of aluminate type CAC in form of CA, C2AS, CA2, and C12A7. Preferably, the ordinary Portland cement according to the present invention contains an aluminate phase and may additionally contain at least one sulfate source, preferably calcium sulfate source. The calcium sulfate source may be selected from calcium sulfate dihydrate, anhydrite, α- and β-hemihydrate, i.e. α-bassanite and β-bassanite, or mixtures thereof. Preferably the calcium sulfate is α-bassanite and/or β-bassanite.

In a preferred embodiment, the ordinary Portland cement comprises at least 3 wt.-%, more preferably at least 4 wt.-%, and even more preferably at least 4.5 wt.-%, of CaSO4.X H2O, wherein x is selected from 0 to 1.5. It is further preferred, that the ordinary Portland cement comprises from at least 3 to less than 7 wt.-%, more preferably from at least 4 to 6 wt.-%, and even more preferably 4.5. to 5.5 wt.-%, of CaSO₄·x H2O, wherein x is selected from 0 to 1.5.

Preferably, the C3A, C4AF, CA, C2AS, CA2, C12A7, and CaSO4·x H₂O are determined using quantitative X-ray diffraction (XRD). In this connection it is preferred to perform Rietveld refinement for the analysis.

In a preferred embodiment, the ordinary Portland cement comprises at least 5 wt.-%, more preferably at least 10 wt.-%, and even more preferably at least 15 wt.-%, of sulfoaluminate types such as yeelimite having the chemical formula 4CaO.3Al₂O₃.SO₃ or C₄A₃$ in cement notation.

In a preferred embodiment, the ordinary Portland cement comprises CaSO₄·x H₂O, wherein x is selected from 0 to 1.5, and Al₂O₃ and wherein the weight ratio of the CaSO₄·x H₂O to the amount of Al₂O₃ is from 1:3 to 4:1, preferably from 1:2 to 3:1.

In a preferred embodiment, the Portland cement clinker has a Blaine surface area of at least 3800 cm²/g, preferably of at least 4500 cm²/g. The Blaine surface area is used as parameter for grinding fineness. Finer milling allows for higher reactivity. The Blaine surface area may be determined according to DIN EN 196-6.

Preferably, the binder composition comprises the calcium sulfate x H₂O in an amount of 5 to 18 wt.-%, more preferably of 6 to 15 wt.-%, based on the total weight of the binder composition.

In a preferred embodiment, x of the calcium sulfate x H₂O is selected from 0 to 2, preferably 0.

It is to be understood that the calcium sulfate x H₂O in the binder composition may be derived from the applied cement (e.g. from ordinary Portland cement) and from supplementary added calcium sulfate. Preferable, the calcium sulfate x H₂O in the binder composition is derived from the applied cement and from supplementary added calcium sulfate.

Preferably, the binder composition comprises the inorganic sulfate source having a solubility higher than 100 g/l at 20° C. in an amount of 0.4 to 8 wt.-%, more preferably of 0.5 to 6 wt.-%, based on the total weight of the binder composition.

In a preferred embodiment, the inorganic sulfate source has a solubility from more than 100 to 1500 g/l at 20° C.

In a preferred embodiment, the inorganic sulfate source is an alkali sulfate selected from the group consisting of potassium sulfate, potassium bisulfate, sodium sulfate, sodium bisulfate, lithium sulfate, and mixtures thereof, preferably sodium sulfate.

Preferably, the binder composition comprises the polyalcohol (and/or metal salts thereof) in an amount of 0.2 to 4.5 wt.-%, more preferably of 0.3 to 4.0 wt.-%, based on the total weight of the binder composition.

In a preferred embodiment, the polyalcohol (and/or metal salts thereof) is selected from the group consisting of i) NR¹R²R³, wherein R¹ to R³ are independently C₁-C₆-hydroxyalkyl, (CH₂O)ₙ—OH, (CH₂CH₂O)ₙ—OH, (CH₂CH₂CH₂O)ₙ—OH, (CHOH)ₙ—C(═O)H, or (CHOH)ₙ—CH₂OH, wherein n is an integer from 1 to 10; ii) R⁵—(CHOH)ₒ-R⁴, wherein R⁴ and R⁵ are independently C₁-C₆-hydroxyalkyl, C₂-C₆-hydroxyalkenyl, C₁-C₆-aminoalkyl, —OH, C₁-C₅-alkyl, C(═O)H, or C(═O) OH, wherein o is an integer from 0-5; and mixtures thereof.

Preferably, in NR¹R²R³, R¹ to R³ are independently C₁-C₆-hydroxyalkyl, (CH₂O)ₙ—OH, (CH₂CH₂O)ₙ—OH, (CH₂CH₂CH₂O)ₙ—OH, (CHOH)ₙ—C(═O)H, or (CHOH)ₙ—CH₂OH, wherein n is an integer from 1 to 5, more preferably R¹ to R³ are independently C₁-C₄-hydroxyalkyl, (CH₂O)ₙ—OH, (CH₂CH₂O), —OH, (CH₂CH₂CH₂O), —OH, (CHOH), —C(═O)H, or (CHOH), —CH₂OH, wherein n is an integer from 1 to 3, even more preferably R¹ to R³ are independently C₂-C₃-hydroxyalkyl, (CH₂O)ₙ—OH, (CH₂CH₂O)ₙ—OH, (CH₂CH₂CH₂O), —OH, (CHOH)ₙ—C(═O)H, or (CHOH)ₙ—CH₂OH, wherein n is an integer from 1 to 3. In a preferred embodiment, in NR¹R²R³, R¹ to R³ are the same. In this connection, it is preferred that each R¹ to R³ is C₂-C₃-hydroxyalkyl, (CH₂O)ₙ—OH, (CH₂CH₂O)ₙ—OH, (CH₂CH₂CH₂O)ₙ—OH, (CHOH), —C(═O)H, or (CHOH)ₙ—CH₂OH, wherein n is an integer from 1 to 3, and in particular that each R¹ to R³ is C₂-C₃-hydroxyalkyl. In a particular embodiment, NR¹R²R³ is triethanolamine.

Preferably, the binder composition comprises the above-defined NR¹R²R³ in an amount of 0.05 to 2.0 wt.-%, more preferably of 0.08 to 1.75 wt.-%, and in particular of 0.1 to 1.5 wt.-%, based on the total weight of the binder composition.

Preferably, in R⁵—(CHOH)ₒ—R⁴, R⁴ and R⁵ are independently C₁-C₆-hydroxyalkyl, C₂-C₆-hydroxyalkenyl, C₁-C₆-aminoalkyl, —OH, C₁-C₅-alkyl, C(═O)H, or C(═O)OH, wherein o is an integer from 0-3, more preferably R⁴ and R⁵ are independently C₁-C₃-hydroxyalkyl, C₂-C₃-hydroxyalkenyl, C₁-C₃-aminoalkyl, —OH, C₁-C₅-alkyl, C(═O)H, or C(═O)OH, wherein o is an integer from 1-2, even more preferably R⁴ and R⁵ are independently C₁-C₂-hydroxyalkyl, C₂-C₃-hydroxyalkenyl, C₁-C₂-aminoalkyl, —OH, C₁-C₅-alkyl, C(═O)H, or C(═O)OH, wherein o is an integer from 1-2. In a preferred embodiment, in R⁵—(CHOH)ₒ—R⁴, R⁴ and R⁵ are the same. In this connection, it is preferred that each R⁴ and R⁵ is C₁-C₂-hydroxyalkyl, C₂-C₃-hydroxyalkenyl, C₁-C₂-aminoalkyl, —OH, C₁-C₅-alkyl, C(═O)H, or C(═O)OH, wherein o is an integer from 1-2, and in particular that each R⁴ and R⁵ is C₁-C₂-hydroxyalkyl, wherein o is an integer from 1-2. In a particular embodiment, R⁵-(CHOH)ₒ-R⁴ is glycerol.

Preferably, the binder composition comprises the above-defined R⁵-(CHOH)ₒ-R⁴ in an amount of 0.15 to 3.0 wt.-%, more preferably of 0.15 to 2.75 wt.-%, and in particular of 0.2 to 2.5 wt.-%, based on the total weight of the binder composition.

In a preferred embodiment, the binder composition comprises at least two different polyalcohol (and/or metal salts thereof). Preferably, the polyalcohol (and/or metal salts thereof) is a mixture of i) NR¹R²R³, wherein R¹ to R³ are independently C₁-C₆-hydroxyalkyl, (CH₂O)ₙ—OH, (CH₂CH₂O)ₙ—OH, (CH₂CH₂CH₂O)ₙ—OH, (CHOH)ₙ—C(═O)H, or (CHOH)ₙ—CH₂OH, wherein n is an integer from 1 to 10, and ii) R⁵—(CHOH)ₒ—R⁴, wherein R⁴ and R⁵ are independently C₁-C₆-hydroxyalkyl, C₂-C₆-hydroxyalkenyl, C₁-C₆-aminoalkyl, —OH, C₁-C₅-alkyl, C(═O)H, or C(═O)OH, wherein o is an integer from 0-5.

In a preferred embodiment, the polyalcohol (and/or metal salts thereof) is selected from the group consisting of i) NR¹R²R³, wherein R¹ to R³ are independently C₁-C₆-hydroxyalkyl; ii) R⁵-(CHOH)ₒ—R⁴, wherein R⁴ and R⁵ are independently C₁-C₆-hydroxyalkyl, wherein o is an integer from 0-1; and mixtures thereof, preferably wherein the polyalcohol (and/or metal salts thereof) is a mixture of i) NR¹R²R³, wherein R¹ to R³ are C₂-C₃-hydroxyalkyl and ii) R⁵—(CHOH)ₒ—R⁴, wherein R⁴ and R⁵ are independently C₁-C₂-hydroxyalkyl, wherein o is an integer from 0-1, and in particular wherein the polyalcohol is a mixture of i) triethanolamine and ii) glycerol.

In a particular embodiment, the metal salts of the polyalcohol is a mixture of i) triethanolamine calcium salt and ii) calcium glycerolate.

The metal salt of the polyalcohol is preferably a multivalent metal salt, which is preferably selected from the group consisting of earth alkali metals, scandium, titanium, vanadium, chromium, manganese, iron, cobalt, nickel, copper, zinc and aluminum.

Earth alkali metal include beryllium, magnesium, calcium, strontium, and barium. In a preferred embodiment, the earth alkali metal is calcium.

Preferably, the binder composition comprises the carbonate in an amount of 0.4 to 4.0 wt.-%, more preferably of 0.5 to 3.0 wt.-%, based on the total weight of the binder composition.

In a preferred embodiment, the carbonate has a solubility of more than 0.1 g/l at 20° C., preferably of more than 1 g/l at 20° C.; more preferably of more than 10 g/l at 20° C., and in particular of more than 50 g/l at 20° C. It is also preferred that the carbonate has a solubility of 0.1 to 500 g/l at 20° C., preferably of 1 to 400 g/l at 20° C., more preferably of 10 to 300 g/l at 20° C., and in particular of 50 to 200 g/l at 20° C.

In a preferred embodiment, the carbonate is an organic carbonate selected from the group consisting of ethylene carbonate, propylene carbonate, glycerin carbonate, and mixtures thereof.

In a preferred embodiment, the carbonate is an alkali carbonate selected from the group consisting of sodium carbonate, sodium bicarbonate, potassium carbonate, potassium bicarbonate, lithium carbonate, lithium bicarbonate, and mixtures thereof, more preferably sodium bicarbonate.

In another preferred embodiment, the carbonate is selected from the group consisting of ethylene carbonate, propylene carbonate, glycerin carbonate, sodium carbonate, sodium bicarbonate, potassium carbonate, potassium bicarbonate, lithium carbonate, lithium bicarbonate, and mixtures thereof.

Preferably, the binder composition comprises the component F) in an amount 0.11 to 3.0 wt.-%, more preferably of 0.3 to 2.0 wt.-%, based on the total weight of the binder composition.

As already above-described, component F) is selected from the group consisting of a compound of formula (I), a polycondensate of said compound of formula (I), and mixtures thereof, wherein formula (I) is represented by

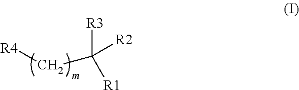

wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH(OH)—SO₃X;
R3 is H, COOX, C₃-C₆ alkyl which may be substituted by 1 to 6, preferably 1 to 5, OH or C₁-C₆ alkoxy;
m is 0 or 1; or
R¹ and R² taken together with the carbon atom to which they are attached form a carbonyl group provided m is 0;
R⁴ is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and
Z is CH₂ or CH(OH).

In a preferred embodiment, the component F) comprises a compound of formula (I), wherein R2 is SO₃X and/or R4 is COOH. In this connection, it is further preferred that m is 0.

In a preferred embodiment, the component F) comprises hydroxycarboxylic acid or the polycondensate of said hydroxycarboxylic acid or the sulfite addition product of said hydroxycarboxylic acid or citric acid or tartaric acid, preferably wherein the hydroxycarboxylic acid or the polycondensate of said hydroxycarboxylic acid or the sulfite addition product of said hydroxycarboxylic acid is glyoxylic acid or a polycondensate of glyoxylic acid or a sulfite addition product of glyoxylic acid, more preferably wherein the polycondensate of glyoxylic acid is an amine-glyoxylic acid condensate, even more preferably wherein the amine-glyoxylic acid condensate is selected from the group consisting of a melamine-glyoxylic acid condensate, a urea-glyoxylic acid condensate, a melamine-urea-glyoxylic acid condensate, and a polyacrylamide-glyoxylic acid condensate, in particular urea-glyoxylic acid condensate.

In a preferred embodiment, the component F) comprises a salt of formula (I) having the following moieties

R2 is H,

R3 is C₃-C₆ alkyl which may be substituted by 1 to 5 OH, and

R4 is COOY, and

Y is X being an alkali metal, preferably wherein the salt is sodium gluconate.

In a preferred embodiment, the binder composition comprises at least two components of component F). Preferably, the component F) comprises at least two compounds selected from the group consisting of a compound of formula (I) and a polycondensate of said compound of formula (I), more preferably wherein component F) comprises a mixture of a compound of formula (I) and a polycondensate of said compound of formula (I), still more preferably wherein the component F) comprises a polycondensate of glyoxylic acid and a salt of formula (I) having the following moieties

R2 is H,

R3 is C₃-C₆ alkyl which may be substituted by 1 to 5 OH, and

R4 is COOY, and

Y is X being an alkali metal, preferably wherein the salt is sodium gluconate.

In a particular embodiment, the binder composition comprises a polycondensate of glyoxylic acid and sodium gluconate.

Preferably, the binder composition comprises the dispersant in an amount of 0.02 to 0.9 wt.-%, more preferably of 0.03 to 0.8 wt.-%, based on the total weight of the binder composition.

Charge density of the polymer was calculated assuming that all acid groups (sulfonate, phosphate and Carboxylate) are fully deprotonated. Charge density p is calculated with p

$$ρ = \frac{N ( neg . charges )}{m}$$

(N=number of negative charges; m=total mass of polymer).

In a preferred embodiment, the dispersant has a charge density of more than 1.20 μeq/g, preferably of more than 1.2 to 14 μeq/g, more preferably of 1.5 to 10.0 μeq/g, and in particular of 2.0 to 5.0 μeq/g.

In a preferred embodiment, the dispersant is a comb polymer comprising units having acid functions having at least one structural unit of the general formulae (Ia), (Ib), (Ic) and/or (Id):

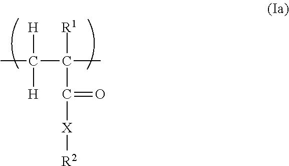

in which

R¹ is H or an unbranched or branched C₁-C₄ alkyl group, CH₂COOH or CH₂CO—X—R₂, preferably H or CH₃;

X is NH—(CₙH₂ₙ), O (CₙH₂ₙ) with n=1, 2, 3 or 4, where the nitrogen atom or the oxygen atom is bonded to the CO group, or is a chemical bond, preferably X is chemical bond or O (CₙH₂ₙ);

R² is OM, PO₃M₂, or O—PO₃M₂, with the proviso that X is a chemical bond if R² is OM;

[symbol]

in which

R³ is H or an unbranched or branched C₁-C₄ alkyl group, preferably H or CH₃;

n is 0, 1, 2, 3 or 4, preferably 0 or 1;

R⁴ is PO₃M₂, or O—PO₃M₂;

[symbol]

in which

R⁵ is H or an unbranched or branched C₁-C₄ alkyl group, preferably H;

Z is O or NR⁷, preferably O;

R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂, and

n is 1, 2, 3 or 4, preferably 1, 2 or 3;

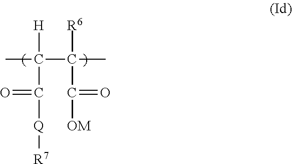

in which

R⁶ is H or an unbranched or branched C₁-C₄ alkyl group, preferably H;

Q is NR⁷ or O, preferably O;

R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂,

n is 1, 2, 3 or 4, preferably 1, 2 or 3; and each M independently of any other is H or a cation equivalent.

In a preferred embodiment, the dispersant is a comb polymer comprising units having a polyether side chain having at least one structural unit of the general formulae (IIa), (IIb), (IIc) and/or (IId):

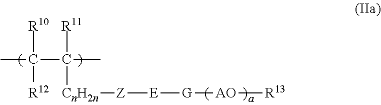

in which

R¹⁰, R¹¹ and R¹² independently of one another are H or an unbranched or branched C₁-C₄ alkyl group;

Z is O or S;

E is an unbranched or branched C₁-C₆ alkylene group, a cyclohexylene group, CH₂-C₆H₁₀, 1,2-phenylene, 1,3-phenylene or 1,4-phenylene;

G is O, NH or CO—NH; or

E and G together are a chemical bond;

A is CₓH₂ₓ with x=2, 3, 4 or 5, preferably 2 or 3, or is CH₂CH(C₆H₅);

n is 0, 1, 2, 3, 4 or 5, preferably 0, 1 or 2;

a is an integer from 2 to 350, preferably 5 to 150, more preferably 20-135, most preferred 60-135;

R¹³ is H, an unbranched or branched C₁-C₄ alkyl group, CO—NH₂ and/or COCH₃;

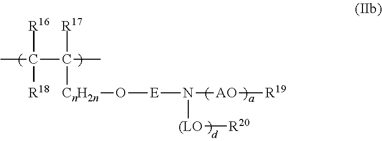

in which

R¹⁶, R¹⁷ and R¹⁸ independently of one another are H or an unbranched or branched C₁-C₄ alkyl group;

E is an unbranched or branched C₁-C₆ alkylene group, a cyclohexylene group, CH₂-C₆H₁₀, 1,2-phenylene, 1,3-phenylene, or 1,4-phenylene, or is a chemical bond;

A is CₓH₂ₓ with x=2, 3,4 or 5, preferably 2 or 3, or is CH₂CH(C₆H₅);

n is 0, 1, 2, 3, 4 and/or 5, preferably 0, 1 or 2;

L is CₓH₂ₓ with x=2, 3, 4 or 5, preferably 2 or 3, or is CH₂—CH(C₆H₅);

a is an integer from 2 to 350, preferably 5 to 150;

d is an integer from 1 to 350, preferably 5 to 150;

R¹⁹ is H or an unbranched or branched C₁-C₄ alkyl group;

R²⁰ is H or an unbranched C₁-C₄ alkyl group;

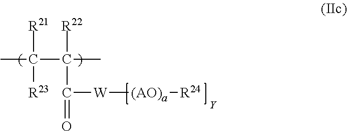

in which
R²¹, R²² and R²³ independently of one another are H or an unbranched or branched C₁-C₄ alkyl group;
W is O, NR²⁵, or is N;
Y is 1 if W=O or NR²⁵, and is 2 if W=N;
A is CₓH₂ₓ with x=2, 3, 4 or 5, preferably 2 or 3, or is CH₂CH(C₆H₅);
a is an integer from 2 to 350, preferably 5 to 150, more preferably 20-135, most preferred 60-135;
R²⁴ is H or an unbranched or branched C₁-C₄ alkyl group; and
R²⁵ is H or an unbranched or branched C₁-C₄ alkyl group;

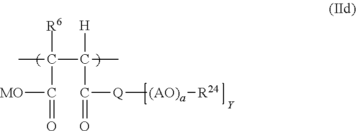

in which
R⁶ is H or an unbranched or branched C₁-C₄ alkyl group;
Q is NR¹⁰, N or O;
Y is 1 if W=O or NR¹⁰ and is 2 if W=N;
R10 is H or an unbranched or branched C₁-C₄ alkyl group; and
A is CₓH₂ₓ with x=2, 3, 4 or 5, preferably 2 or 3, or is CH₂C (C₆H₅)H;
R24 is H or an unbranched or branched C₁-C₄ alkyl group;
M is H or a cation equivalent; and
a is an integer from 2 to 350, preferably 5 to 150, more preferably 20-135, most preferred 60-135.

In a preferred embodiment, the ratio of I to Il in the comb polymer is 1/1 to 10/1, more preferred 3/1 to 15/1.

In a preferred embodiment, the molecular weight of the comb polymer is from 10 kD to 300 kD, more preferred from 20 kD to 100 kD as measured by GPC using PEG as a calibration method.

In a preferred embodiment, the dispersant is a phosphorylated polycondensation product comprising structural units (III) and (IV):

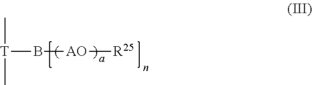

in which
T is a substituted or unsubstituted phenyl or naphthyl radical or a substituted or unsubstituted heteroaromatic radical having 5 to 10 ring atoms, of which 1 or 2 atoms are heteroatoms selected from N, O and S;
n is 1 or 2;
B is N, NH or O, with the proviso that n is 2 if B is N and with the proviso that n is 1 if B is NH or O;
A is an unbranched or branched alkylene with 2 to 5 carbon atoms or CH₂CH (C₆H₅);
a is an integer from 1 to 300;
R²⁵ is H, a branched or unbranched C₁ to C₁₀ alkyl radical, Cs to Cs cycloalkyl radical, aryl radical, or heteroaryl radical having 5 to 10 ring atoms, of which 1 or 2 atoms are heteroatoms selected from N, O and S;
where the structural unit (IV) is selected from the structural units (IVa) and (IVb):

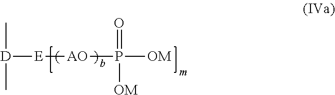

in which
D is a substituted or unsubstituted phenyl or naphthyl radical or a substituted or unsubstituted heteroaromatic radical having 5 to 10 ring atoms, of which 1 or 2 atoms are heteroatoms selected from N, O and S;
E is N, NH or O, with the proviso that m is 2 if E is N and with the proviso that m is 1 if E is NH or O;
A is an unbranched or branched alkylene with 2 to 5 carbon atoms or CH₂CH (C₆H₅);
b is an integer from 0 to 300;
M independently at each occurrence is H or a cation equivalent;

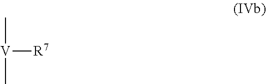

in which
V is a substituted or unsubstituted phenyl or naphthyl radical and is optionally substituted by 1 or two radicals selected from R⁸, OH, OR⁸, (CO) R⁸, COOM, COOR⁸, SO₃ R⁸ and NO₂;
R⁷ is COOM, OCH₂COOM, SO₃M or OPO₃M₂;
M is H or a cation equivalent; and
R⁸ is C₁-C₄ alkyl, phenyl, naphthyl, phenyl-C₁-C₄ alkyl or C₁-C₄ alkylphenyl.

The dispersants comprising structural units (I) and (II) can be prepared by conventional methods, for example by free radical polymerization. The preparation of the dispersants is, for example, described in EP0894811, EP1851256, EP2463314, and EP0753488.

In a preferred embodiment, the binder composition further comprises
H) a supplementary cementitious material in an amount of from 0.5 to 68.989 wt.-%, preferably 5 to 60 wt.-%, more preferably 10 to 50 wt.-%, and in particular 15 to 45 wt.-%, based on the total weight of the binder composition, preferably wherein the supplementary cementitious material is selected from the group consisting of slag, fly ash, natural pozzolans, calcinated clay, silica fume, limestone, and mixtures thereof, preferably limestone. In a specific embodiment, the binder composition comprises the supplementary cementitious material in an amount of 5 to 65.57 wt.-%; more preferably of 10 to 61.86 wt.-%, based on the total weight of the binder composition.

In a further preferred embodiment, the binder composition further comprises at least two, different supplementary cementitious material, preferably wherein the at least two, different supplementary cementitious materials are selected from the group consisting of slag, fly ash, natural pozzolans, calcinated clay, silica fume, limestone, and mixtures thereof. Preferably, the binder composition further comprises at least two, different supplementary cementitious material selected from the group consisting of slag, calcinated clay, limestone. In a particular embodiment, the binder composition further comprises a combination of calcinated clay and limestone or a combination of slag and limestone.

In a further preferred embodiment, the supplementary cementitious material has a Dv90 of less than 200 μm. The Dv90 (by volume) corresponds to the 90^{th} percentile of the particle size distribution, meaning that 90% of the particles have a size of the Dv90 or smaller and 10% have a size larger than the Dv90. Generally, the Dv90 and other values of the same type are characteristic of the granulometric profile (volume distribution) of a collection of particles or grains. Conformity with the requirement that 90% of the particles have a size of 200 μor less is ensured if at least 90% by volume of the particles pass a sieve having a mesh opening of 200 μm.

Alternatively, the Dv90 may be calculated from a particle size distribution measured by static laser diffraction using a Malvern Mastersizer 2000.

In a preferred embodiment of the present invention, the Portland cement clinker and the calcium sulfate are present in a weight ratio of from 60:1 to 2:1, preferably from 50:1 to 3:1, more preferably from 40:1 to 4:1, or from 20:1 to 3:1, or from 10:1 to 4:1.

In a preferred embodiment of the present invention, the Portland cement clinker and the inorganic sulfate source having a solubility higher than 100 g/l at 20°° C. are present in a weight ratio of from 60:1 to 2:1, preferably from 50:1 to 3:1, more preferably from 40:1 to 4:1, or from 40:1 to 5:1, or from 30:1 to 10:1.

In a preferred embodiment, the Portland cement clinker and the supplementary cementitious material are present in a weight ratio of from 2:1 to 1:5, preferably from 2:1 to 1:2, more preferably from 1.8:1 to 1:1.8 or from 1.8:1 to 1:1.5, or from 1.5:1 to 1:1.

In a preferred embodiment, the Portland cement clinker and the polyalcohol (and/or metal salts thereof) are present in a weight ratio of from 500:1 to 10:1, preferably 300:1 to 50:1, more preferably 180:1 to 80:1.

In a preferred embodiment, the Portland cement clinker and the carbonate are present in a weight ratio of from 400:1 to 10:1, preferably 300:1 to 40:1, more preferably 150:1 to 60:1.

In a preferred embodiment, the Portland cement clinker and the component F) are present in a weight ratio of from 500:1 to 10:1, preferably 300:1 to 50:1, more preferably 200:1 to 100:1.

In a preferred embodiment, the Portland cement clinker and the dispersant present in a weight ratio of from 2500:1 to 1000:1, preferably 2000:1 to 1100, more preferably 1800:1 to 1200:1.

In a preferred embodiment of the present invention, the above-defined binder composition is mixed with at least one aggregate to provide a construction material composition comprising a binder composition and at least one aggregate. A suitable aggregate is e.g. sand such as Normensand and Quartzsand.

As outlined above, the present invention relates in a second aspect to the use of a retarding mixture (RM) comprising
RM1) a carbonate selected from the group consisting of organic carbonate, alkali carbonate, and mixtures thereof, in an amount of from 30 to 60 wt.-%;
RM2) NR¹R²R³ and/or metal salts thereof, wherein R¹ to R³ are independently C₁-C₆-hydroxyalkyl, in an amount of from 5 to 20 wt.-%;
RM3) R⁵—(CHOH)ₙ—R⁴ and/or metal salts thereof, wherein R⁴ and R5 are independently C₁-C₆-hydroxyalkyl, wherein o is an integer from 0-1, in an amount of from 10 to 30 wt.-%;
RM4) a component RM4) selected from the group consisting of a compound of formula (I), a polycondensate of said compound of formula (I), and mixtures thereof, wherein formula (I) is represented by

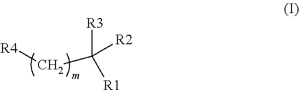

wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH (OH)—SO₃X;
R³ is H, COOX, C₃-C₆ alkyl which may be substituted by 1 to 6, preferably 1 to 5, OH or C₁-C₆ alkoxy;
m is 0 or 1; or
R¹ and R² taken together with the carbon atom to which they are attached form a carbonyl group provided m is 0;
R⁴ is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and
Z is CH₂ or CH (OH), in an amount of from 12 to 50 wt.-%;
each based on the total weight of the retarding mixture (RM),
and a dispersant having a charge density of more than 0.80 μeq/g for improving the spread and/or the compressive strength of a construction material composition comprising Portland cement clinker, calcium sulfate, sodium sulfate, and optionally supplementary cementitious material.

In a preferred embodiment, the present invention relates to the use of a retarding mixture (RM) comprising

RM1) a carbonate selected from the group consisting of organic carbonate, alkali carbonate, and mixtures thereof, in an amount of from 30 to 60 wt.-%;

RM2) NR¹R²R³, wherein R¹ to R³ are independently C₁-C₆-hydroxyalkyl, in an amount of from 5 to 20 wt.-%;

RM3) R⁵—(CHOH)ₙ-R⁴, wherein R⁴ and R⁵ are independently C₁-C₆-hydroxyalkyl, wherein o is an integer from 0-1, in an amount of from 10 to 30 wt.-%;

RM4) a component RM4) selected from the group consisting of a compound of formula (I), a polycondensate of said compound of formula (I), and mixtures thereof, wherein formula (I) is represented by

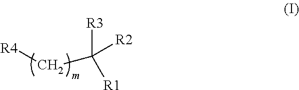

wherein
R1 is OH;
R² is H, OH, C₁-C₆ alkoxy, —SO₂X, —SO₃X, —OSO₃X, —PO, —PO₃X₂, —OPO₃X₂, —Z—COOX or —CH(OH)—SO₃X;
R³ is H, COOX, C₃-C₆ alkyl which may be substituted by 1 to 6, preferably 1 to 5, OH or C₁-C₆ alkoxy;
m is 0 or 1; or
R¹ and R² taken together with the carbon atom to which they are attached form a carbonyl group provided m is 0;
R⁴ is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and

Z is CH₂ or CH (OH), in an amount of from 12 to 50 wt.-%;

each based on the total weight of the retarding mixture (RM),

and a dispersant having a charge density of more than 0.80 μeq/g for improving the spread and/or the compressive strength of a construction material composition comprising Portland cement clinker, calcium sulfate, sodium sulfate, and optionally supplementary cementitious material.

The metal salts of the NR¹R²R³ and of the R⁵—(CHOH)ₙ-R⁴ are independently preferably a multivalent metal salt, which are independently preferably selected from the group consisting of earth alkali metals, scandium, titanium, vanadium, chromium, manganese, iron, cobalt, nickel, copper, zinc and aluminum.

Earth alkali metal include beryllium, magnesium, calcium, strontium, and barium. In a preferred embodiment, the earth alkali metal is calcium.

It is to be understood that the spread is improved if the spread of the construction material composition is increased after addition of RM and the dispersant compared to spread of the construction material composition, wherein one of the specific components is missing. The spread preferably is determined according to EN 1015-3.

It is further to be understood that the compressive strength is improved if the compressive strength of the construction material composition is increased after addition of RM and the dispersant compared to the compressive strength of the construction material composition, wherein one of the specific components is missing. The compressive strength preferably is determined according to DIN EN 1015-11.

In a preferred embodiment, the spread and the compressive strength are improved.

In a preferred embodiment, the retarding mixture (RM) comprises carbonate RM1) in an amount of 35 to 50 wt.-%; more preferably of 38 to 45 wt.-%, based on the total weight of the retarding mixture (RM).

In a preferred embodiment, the retarding mixture (RM) comprises NR¹R²R³ and/or metal salts thereof RM2) in an amount of 6 to 15 wt.-%; more preferably of 8 to 13 wt.-%, based on the total weight of the retarding mixture (RM). In a preferred embodiment, in NR¹R²R³ and/or metal salts thereof RM2), R¹ to R³ are independently C₁-C₅-hydroxyalkyl, preferably C₁-C₄-hydroxyalkyl, more preferably C₂-C₄-hydroxyalkyl, and in particular C₂-C₃-hydroxyalkyl. Preferably R¹ to R³ are the same. In a particular embodiment, NR¹R²R³ and/or metal salts thereof RM2) is triethanolamine. In another particular embodiment, NR¹R²R³ and/or metal salts thereof RM2) is triethanolamine calcium salt.

In a preferred embodiment, the retarding mixture (RM) comprises R⁵—(CHOH)ₙ—R⁴ and/or metal salts thereof RM3) in an amount of 15 to 26 wt.-%; more preferably of 18 to 24 wt.-%, based on the total weight of the retarding mixture (RM). In a preferred embodiment, in R⁵—(CHOH)ₙ—R⁴ and/or metal salts thereof RM3), R⁴ and R⁵ are independently C₁-C₅-hydroxyalkyl, preferably C₁-C₄-hydroxyalkyl, more preferably C¹-C³-hydroxyalkyl, and in particular C₁-C₂-hydroxyalkyl, wherein o is an integer from 0-1. In a particular embodiment, R⁵—(CHOH)ₙ—R⁴ and/or metal salts thereof RM5) is glycerol. In another particular embodiment, R⁵—(CHOH)ₙR⁴ and/or metal salts thereof is calcium glycerolate.

In a particular embodiment, RM2) is triethanolamine calcium salt and RM3) is calcium glycerolate.

In a preferred embodiment, the retarding mixture (RM) comprises component RM4) in an amount of 18 to 45 wt.-%; more preferably of 20 to 35 wt.-%, based on the total weight of the retarding mixture (RM).

In a preferred embodiment, the retarding mixture (RM) comprises a mixture of glycerol and triethanolamine in a ratio of 1/1 to 9/1.

The preferred embodiments of component RM4) correspond with the preferred embodiments of component F) as above-outlined.

Preferably, component RM4) comprises a compound of formula (I), wherein R² is SO₃X and/or R⁴ is COOH. In this connection, it is further preferred that m is 0.

In a preferred embodiment, the component RM4) comprises hydroxycarboxylic acid or the polycondensate of said hydroxycarboxylic acid or the sulfite addition product of said hydroxycarboxylic acid or citric acid or tartaric acid, preferably wherein the hydroxycarboxylic acid or the polycondensate of said hydroxycarboxylic acid or the sulfite addition product of said hydroxycarboxylic acid is glyoxylic acid or a polycondensate of glyoxylic acid or a sulfite addition product of glyoxylic acid, more preferably wherein the polycondensate of glyoxylic acid is an amine-glyoxylic acid condensate, even more preferably wherein the amine-glyoxylic acid condensate is selected from the group consisting of a melamine-glyoxylic acid condensate, a urea-glyoxylic acid condensate, a melamine-urea-glyoxylic acid condensate, and a polyacrylamide-glyoxylic acid condensate, in particular urea-glyoxylic acid condensate.

In a preferred embodiment, the component RM4) comprises a salt of formula (I) having the following moieties

R2 is H,

R3 is C₃-C₆ alkyl which may be substituted by 1 to 5 OH, and

R4 is COOY, and

Y is X being an alkali metal, preferably wherein the salt is sodium gluconate.

In a preferred embodiment, the retarding mixture (RM) comprises at least two components of component RM4). Preferably, the component RM4) comprises at least two compounds selected from the group consisting of a compound of formula (I) and a polycondensate of said compound of formula (I), more preferably wherein component RM4) comprises a mixture of a compound of formula (I) and a polycondensate of said compound of formula (I), still more preferably wherein the component RM4) comprises a polycondensate of glyoxylic acid and a salt of formula (I) having the following moieties

R2 is H,

R3 is C₃-C₆ alkyl which may be substituted by 1 to 5 OH, and

R4 is COOY, and

Y is X being an alkali metal, preferably wherein the salt is sodium gluconate.

In a particular embodiment, the retarding mixture (RM) comprises a polycondensate of glyoxylic acid and sodium gluconate.

Preferably, the retarding mixture (RM) comprises a polycondensate of the compound of formula (I) in an amount of 12 to 50 wt.-%, more preferably of 15 to 35 wt.-%, and in particular of 17 to 30 wt.-%, based on the total weight of the retarding mixture (RM).

Preferably, the retarding mixture (RM) comprises a salt of the compound of formula (I) in an amount of 3 to 20 wt.-%, more preferably of 4 to 15 wt.-%, and in particular of 5 to 10 wt.-%, based on the total weight of the retarding mixture (RM).

Preferably, the construction material composition comprises a binder composition and at least one aggregate such as sand, wherein said binder composition comprises the retarding mixture (RM), the dispersant, and Portland cement clinker.

In a preferred embodiment, the retarding mixture (RM) is comprised in the binder composition in an amount of 0.5 to 7.0 wt.-%, preferably of 0.6 to 5.0 wt.-%, more preferably of 0.8 to 4.0 wt.-%, and in particular of 1.0 to 3.0 wt.-%, based on the total weight of the binder composition.

In a preferred embodiment, the dispersant is comprised in the binder composition in an amount of from 0.01 to 1 wt.-%, 0.01 to 0.95 wt.-%, preferably 0.02 to 0.9 wt.-%, more preferably 0.02 to 0.85 wt.-%, and in particular of 0.03 to 0.8 wt.-%, based on the total weight of the binder composition. Regarding further preferred embodiments of the dispersant, the same preferred embodiments as for the first aspect apply.

In a preferred embodiment, the binder composition further comprises at least one, preferably at least two supplementary cementitious material.

Regarding further preferred embodiments of the carbonate, binder composition, Portland cement clinker, calcium sulfate, sodium sulfate, and optionally supplementary cementitious material, the same preferred embodiments as for the first aspect apply.

As outlined above, the present invention relates in a third aspect to a concrete comprising the binder composition as outlined in the first aspect. Hence, regarding further preferred embodiments of said binder composition, the same preferred embodiments as for the first aspect apply.

As outlined above, the present invention relates in a fourth aspect to the use of a retarding mixture (RM) comprising

RM1) a carbonate selected from the group consisting of organic carbonate, alkali carbonate, and mixtures thereof, in an amount of from 30 to 60 wt.-%;

RM2) NR¹R²R³ and/or metal salts thereof, wherein R¹ to R³ are independently C₁-C₆-hydroxyalkyl, in an amount of from 5 to 20 wt.-%;

RM3) R⁵—(CHOH)ₒ—R⁴ and/or metal salts thereof, wherein R⁴ and R⁵ are independently C₁-C₆-hydroxyalkyl, wherein o is an integer from 0-1, in an amount of from 10 to 30 wt.-%;

RM4) a component RM4) selected from the group consisting of a compound of formula (I), a polycondensate of said compound of formula (I), and mixtures thereof, wherein formula (I) is represented by

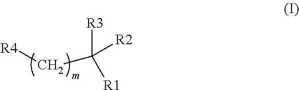

wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH(OH)—SO₃X;
R3 is H, COOX, C₃-C₆ alkyl which may be substituted by 1 to 6, preferably 1 to 5, OH or C₁-C₆ alkoxy;
m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and
Z is CH₂ or CH (OH),
in an amount of from 12 to 50 wt.-%;
each based on the total weight of the retarding mixture (RM),
and a dispersant having a charge density of more than 0.80 μeq/g for retarding the hardening of inorganic binder containing building material formulations and/or for producing building products.

In a preferred embodiment, the present invention relates to the use of a retarding mixture (RM) comprising

RM1) a carbonate selected from the group consisting of organic carbonate, alkali carbonate, and mixtures thereof, in an amount of from 30 to 60 wt.-%;

RM2) NR¹R²R³, wherein R¹ to R³ are independently C₁-C₆-hydroxyalkyl, in an amount of from 5 to 20 wt.-%;

RM3) R⁵—(CHOH)ₒ—R⁴, wherein R⁴ and R⁵ are independently C₁-C₆-hydroxyalkyl, wherein o is an integer from 0-1, in an amount of from 10 to 30 wt.-%;

RM4) a component RM4) selected from the group consisting of a compound of formula (I), a polycondensate of said compound of formula (I), and mixtures thereof, wherein formula (I) is represented by

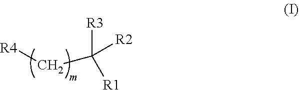

wherein

R1 is OH;

R2 is H, OH, C₁-C₆ alkoxy, —SO₂X, —SO₃X, —OSO₃X, —PO, —PO₃X₂, —OPO₃X₂, —Z—COOX or —CH(OH)—SO₃X;
R3 is H, COOX, C₃-C₆ alkyl which may be substituted by 1 to 6, preferably 1 to 5, OH or C₁-C₆ alkoxy;
m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and

Z is CH₂ or CH (OH),

in an amount of from 12 to 50 wt.-%;

each based on the total weight of the retarding mixture (RM),

and a dispersant having a charge density of more than 0.80 μeq/g for retarding the hardening of inorganic binder containing building material formulations and/or for producing building products.

Preferably, the inorganic binder is a hydraulic binder, a latent hydraulic binder, an inorganic binder based on calcium sulfate, or mixtures thereof. In one preferred embodiment, the inorganic binder is a hydraulic binder, which is selected from Portland cement, calcium aluminate cement, sulfoaluminate cement, and mixtures thereof. In another preferred embodiment, the inorganic binder comprises a mixture of Portland cement and aluminate cement, or a mixture of Portland cement and sulfoaluminate cement or a mixture of Portland cement, aluminate cement and sulfoaluminate cement. In another preferred embodiment, the inorganic binder is a calcium sulfate based binder, which is selected from calcium sulfate dihydrate, calcium sulfate hemihydrate, anhydrite, and mixtures thereof. In yet another preferred embodiment, the inorganic binder is a calcium sulfate based binder in its anhydrous form.

In another preferred embodiment, the inorganic binder may be used in a mortar composition.

The mortar composition may additionally comprise at least one aggregate.

The term “aggregate” is understood to relate to a filler material, i.e. an inert material which essentially does not form hydration products. The aggregate may be selected from quartz, sand, marble, e.g., crushed marble, glass spheres, granite, basalt, limestone, sandstone, calcite, marble, serpentine, travertine, dolomite, feldspar, gneiss, alluvial sands, and mixtures thereof. The packing density of the aggregates should be as high as possible and their particle size distribution ideally constitutes a fuller type sieve curve.

Aggregates may be classified by particle size. Fine aggregates, e.g., sand, generally have a diameter distribution of 150 μm to 5 mm. Coarse aggregates generally have a diameter distribution of more than 5 mm.

The invention also relates to a mixed mortar composition comprising the inorganic binder composition according to the invention, aggregate and water. Preferably, the ratio of water to Portland cement clinker is from 0.2-1.5, preferably, from 0.3-1, more preferably from 0.3-0.7 and most preferably from 0.3-0.5.

The mixed mortar composition can include concrete or grouts. The term “mortar” or “grout” denotes a cement paste to which are added fine aggregates, i.e. aggregates whose diameter is between 150 μm and 5 mm (for example sand), and optionally very fine aggregates. A grout is a mixture of sufficiently low viscosity for filling in voids or gaps. Mortar viscosity is high enough to support not only the mortar's own weight but also that of masonry placed above it. The term “concrete” denotes a mortar to which are added coarse aggregates, i.e. aggregates with a diameter of greater than 5 mm.

In a preferred embodiment, the Portland cement clinker is present in an amount of 180 to 900 kg, more preferred 180-600 kg/per m³ of the freshly mixed mortar composition.

Regarding further preferred embodiments of the components of the retarding mixture (RM) and the dispersant, the same preferred embodiments as for the second aspect apply.

Suitable building products may e.g. be concretes such as on-site concrete, finished concrete parts, pre-cast concrete parts, concrete goods, cast concrete stones, concrete bricks, sprayed concrete (shotcrete), ready-mix concrete, air-placed concrete, 3D printed concrete or mortar, concrete re-pair systems, industrial cement flooring, one-component and two-component sealing slurries, screeds, filling and self-levelling compositions, such as joint fillers or self-levelling underlayments, adhesives, such as building or construction adhesives, thermal insulation composite system adhesives, or tile adhesives, renders, plasters, sealants, coating and paint systems, in particular for tunnels, waste water drains, splash protection and condensate lines, screeds, mortars, such as dry mortars, sag resistant, flowable or self-levelling mortars, drainage mortars, or repair mortars, grouts, such as joint grouts, non-shrink grouts, tile grouts, wind-mill grouts, anchor grouts, flowable or self-levelling grouts, ETICS (external thermal insulation composite systems), EIFS grouts (Exterior Insulation Finishing Systems, swelling explosives, waterproofing membranes, cementitious foams, or gypsum wall boards.

### EXAMPLES

The invention was tested in a mortar with the following recipe:

438.3 g Cement CEM I 52.5 N

394.5 g supplementary cementitious material (limestone power)

44 g CaSO₄ (Anhydride)

1350 g Normensand

568 g Quartzsand (0.1-0.3 mm)

368 g Water

21.9 g Sodium sulfate (Anhydrous)

The used CEM I 52.5 N had the following Composition:

| | |
|---|---|
| C₃S Alite | 56.9 |
| C₂S Belite | 12.0 |
| C₃A sum | 8.9 |
| C₄(A, F) Ferrite | 9.7 |
| CaSO₄ Anhydrite | 2.2 |
| CaSO₄ * 0.5 H₂O Hemihydrate (Bassanite) | 1.5 |
| K₂SO₄ Arcanite | 0.8 |
| K₃Na(SO₄)₂ Aphtitalite | 0.3 |
| CaO Free Lime | 1.8 |
| MgO Periclase | 1.2 |
| CaCO₃ Calcite | 3.4 |
| CaMg(CO₃)₂ Dolomite | 0.6 |
| SiO₂ Quartz | 0.4 |
| Ca(OH)₂ Portlandite | 0.2 |

The production of the cement mortar was done according to EN 196-1:2005 in a mortar mixer with a batch volume of 5 L. The inorganic binder, the additive (if used), and water were placed into the mixing vessel and the mixing was started at 140 rpm of the mixer. After 30 s of mixing the norm sand was added slowly during 30 s. After complete addition of the norm sand the mixer speed was set to 285 rpm and mixing was continued for another 30 s. After that step the mixing was stopped for 90 s. Within the first 30 s of this break of mixing the mortar attached to the wall of the vessel was removed and given to the mortar again. After the break of 90 s the mixing was continued at a mixer speed of 285 rpm. The total mixing time was 4 minutes. The spread of the mortar was determined according to EN 1015-3 directly after the end of mixing (value at 4 min). The compressive strength preferably is determined according to DIN EN 1015-11.

Retarding additive formulation A, which was dosed with 2.5% by weight of cement:

20% Retarder 1

41% NaHCO₃

7% Sodium Gluconate

21% Glycerol

11% TEA

Retarder 1 was synthesized according to WO2019/077050A1: Synthetic procedure A, retarder 7 in table 1, page 24-26.

Several dispersants were used to enhance flowability:

Dispersant 1 is polymerized using ethoxylated hydroxybutylvinyl ether (68 Ethylene oxide) and acrylic acid in a ratio of 1/10. Charge density is 2.68 μeq/g

Dispersant 2 is polymerized using ethoxylated hydroxybutylvinyl ether (68 Ethylene oxide) and acrylic acid in a ratio of 1/3. Charge density is 0.93 μeq/g

Dispersant 3 is polymerized using ethoxylated hydroxybutylvinyl ether (68 Ethylene oxide) and acrylic acid in a ratio of 1/1. Charge density is 0.32 μeq/g

### Experiment 1 (Different Dispersants):

TABLE 1
Formulations of the tested mortars; focus on the use of different dispersants

| | | | Amount | | | | | |
|---|---|---|---|---|---|---|---|---|
| | | Dispersant | retarder | | | 1 d | 7 d | 28 d |
| | | amount/ | formulation | Supple- | | compressive | compressive | compressive |
| | | % | A/ | mentary | Spread/ | strength/ | strength/ | strength/ |
| No. | Dispersant | b.w.o.c. | b.w.o.c. | powder | cm | MPa | MPa | MPa |
| 1 | 1 | 0.07 | 2.5 | Limestone | 25.4 | 9.74 | 38.5 | 43.35 |
| 2 | 2 | 0.07 | 2.5 | Limestone | 21.0 | 9.09 | 35.8 | 43.08 |
| Comp. 1 | 3 | 0.07 | 2.5 | Limestone | 20.4 | 10.51 | 38.4 | 42.8 |
| Comp. 2 | — | — | 2.5 | Limestone | 20.3 | 9.45 | 36.7 | 43.80 |
| Comp. 3 | 1 | 0.07 | — | Limestone | 11.7 | 4.38 | 18.02 | 29.3 |

This experiment shows that the charge density of the dispersant is decisive for receiving a flowable mortar.

### Experiment 2 (Removal of Components of Formulation A):

The following mortar formulation was used:

438.3 g Cement

394.5 g Limestone powder

44 g CaSO₄ (Anhydride)

1350 g Normensand

568 g Quartzsand (0.1-0.3 mm)

368 g Water

0.3 g Dispersant 1

21.9 g Sodium sulfate

TABLE 2
Formulations of the tested mortars;
focus on omission of specific components

| | | | | 1 d | 7 d | 28 d |
|---|---|---|---|---|---|---|
| | | | | compressive | compressive | compressive |
| | Retarder | Removed | Spread/ | strength/ | strength/ | strength/ |
| No. | Amount/g | component | cm | MPa | MPa | MPa |
| 1 | 11.0 g | — | 25.4 | 9.74 | 38.5 | 43.35 |
| Comp. 4 | 10.2 g | Sodium | 21.1 | 6.34 | 33.4 | 40.2 |
| | | gluconate | | | | |
| Comp. 5 | 6.6 g | Sodium | 21.4 | 1.34 | 13.67 | 28.4 |
| | | Carbonate | | | | |
| Comp. 6 | 8.8 g | Retarder 1 | 10 | 1.34 | 4.34 | 18.45 |
| Comp. 7 | 8.7 | Glycerol | 25.3 | 4.56 | 20.02 | 29.2 |
| Comp. 8 | 9.8 | TEA | 25.4 | 4.38 | 18.3 | 20.93 |
| Comp. 3 | — | Formulation | 11.7 | 4.38 | 18.02 | 29.3 |
| | | A | | | | |

### Experiment 3 (Removal of Sodium Sulfate):

The following mortar formulation was used:

438.3 g Cement

394.5 g Limestone powder

44 g CaSO₄ (Anhydride)

1350 g Normensand

568 g Quartzsand (0.1-0.3 mm)

368 g Water

0.3 g Dispersant 1

11 g Formulation A

TABLE 3
Formulations of the tested mortars;
focus on omission of sodium sulfate

| | | | 1 d | 7 d | 28 d |
|---|---|---|---|---|---|
| | Sodium | | compressive | compressive | compressive |
| | Sulfate/ | Spread/ | strength/ | strength/ | strength/ |
| No. | g | cm | MPa | MPa | MPa |
| 1 | 21.9 g | 25.4 | 9.74 | 38.5 | 43.35 |
| Comp. 9 | 0 | 25.3 | 5.67 | 40.55 | 52.15 |

### Experiment 4 (Supplementary Cementitious Materials):

In this experiment the inventive effect has also been tested on calcined clay as supplementary cementitious material.

The following mortar formulation was used:

438.3 g Cement

394.5 g Supplementary powder

44 g CaSO₄

1350 g Normensand

568 g Quartzsand (0.1-0.3 mm)

368 g Water

TABLE 4
Formulations of the tested mortars; focus on different
supplementary cementitious materials

| | | | Dosage | | | 1 d | 7 d | 28 d |
|---|---|---|---|---|---|---|---|---|
| | | Supple- | Dispersant | | | compressive | compressive | compressive |
| | Sodium | mentary | 1/% | Formulation | Spread/ | strength/ | strength/ | strength/ |
| No. | Sulfate/g | Powder | b.w.o.c | A/g | cm | MPa | MPa | MPa |
| 3 | 21.9 | Calcined | 0.5% | 11 g | 18.5 | 13.8 | 58.5 | 78.7 |
| | | clay | | | | | | |
| Comp. | 0 | Calcined | 0.4% | 11 g | 18.3 | 7.4 | 51.8 | 71.4 |
| 10 | | Clay | | | | | | |
| Comp. | 21.9 | Calcined | 0.85% | 0 | 18.1 | 12.3 | 63.9 | 73.3 |
| 11 | | Clay | | | | | | |
| Comp. | 0 | Calcined | 0.65% | 0 | 18.8 | 10.4 | 54.7 | 71.7 |
| 12 | | Clay | | | | | | |

1-15. (canceled)

16. A binder composition comprising
A) Portland cement clinker in an amount of 25 to 94.089 wt.-%;
B) calcium sulfate x H₂O in an amount of 5 to 20 wt.-%, wherein x is selected from 0 to 2;
C) an inorganic sulfate source having a solubility higher than 100 g/l at 20° C. in an amount of 0.3 to 10 wt.-%;
D) polyalcohol and/or metal salts thereof in an amount of 0.2 to 5 wt.-%;
E) a carbonate selected of the group consisting of organic carbonate, alkali carbonate, and mixtures thereof, in an amount of 0.3 to 5 wt.-%;
F) a component F) selected from the group consisting of a compound of formula (I), a polycondensate of said compound of formula (I), and mixtures thereof, wherein formula (I) is represented by 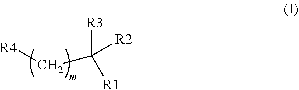
wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH(OH)—SO₃X;
R3 is H, COOX, C₃-C₆ alkyl which may be substituted by 1 to 6 OH or C₁-C₆ alkoxy;
m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and
Z is CH₂ or CH(OH), in an amount of 0.101 to 3.5 wt.-%; and
G) dispersant having a charge density of more than 0.80 μeq/g in an amount of 0.01 to 1 wt.-%;
each based on the total weight of the binder composition.

17. The binder composition according to claim 16,
wherein the polyalcohol and/or metal salts thereof is selected from the group consisting of i) NR¹R²R³, wherein R¹ to R³ are independently C₁-C₆-hydroxyalkyl, (CH₂O)ₙ—OH, (CH₂CH₂O)ₙ—OH, (CH₂CH₂CH₂O)ₙ—OH, (CHOH)ₙ—C(═O)H, or (CHOH)ₙ—CH₂OH, wherein n is an integer from 1 to 10; ii) R⁵—(CHOH)ₒ—R⁴, wherein R⁴ and R⁵ are independently C₁-C₆-hydroxyalkyl, C₂-C₆-hydroxyalkenyl, C₁-C₆-aminoalkyl, —OH, C₁-C₅-alkyl, C(═O)H, or C(═O)OH, wherein o is an integer from 0-5; and mixtures thereof.

18. The binder composition according to claim 16,
wherein the polyalcohol and/or metal salts thereof is selected from the group consisting of
i) NR¹R²R³, wherein R¹ to R³ are independently C₁-C₆-hydroxyalkyl; ii) R⁵—(CHOH)ₒ—R⁴,
wherein R⁴ and R⁵ are independently C₁-C₆-hydroxyalkyl, wherein o is an integer from 0-1;
and mixtures thereof.

19. The binder composition according to claim 16,
wherein the carbonate is an alkali carbonate selected from the group consisting of sodium carbonate, sodium bicarbonate, potassium carbonate, potassium bicarbonate, lithium carbonate, lithium bicarbonate, and mixtures thereof.

20. The binder composition according to claim 16, p1 wherein the inorganic sulfate source is an alkali sulfate selected from the group consisting of potassium sulfate, sodium sulfate, lithium sulfate, and mixtures thereof.

21. The binder composition according to claim 16,
wherein the dispersant has a charge density of more than 1.20 μeq/g.

22. The binder composition according to claim 16,
wherein the dispersant is a comb polymer comprising units having acid functions having at least one structural unit of the general formulae (Ia), (Ib), (Ic) and/or (Id): 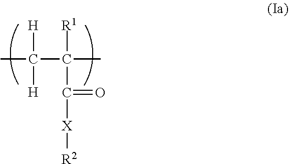
in which
R¹ is H or an unbranched or branched C₁-C₄ alkyl group, CH₂COOH or CH₂CO—X—R²;
X is NH—(CₙH₂ₙ), O(CₙH₂ₙ) with n=1, 2, 3 or 4, where the nitrogen atom or the oxygen atom is bonded to the CO group, or is a chemical bond;
R² is OM, PO₃M₂, or O—PO₃M₂, with the proviso that X is a chemical bond if R² is OM; 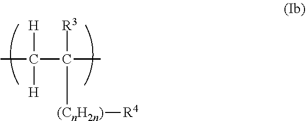
in which
R³ is H or an unbranched or branched C₁-C₄ alkyl group;
n is 0, 1, 2, 3 or 4;
R⁴ is PO₃M₂, or O—PO₃M₂; 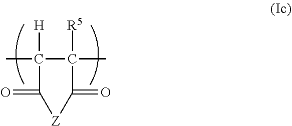
in which
R⁵ is H or an unbranched or branched C₁-C₄ alkyl group;
Z is O or NR⁷;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂, and
n is 1, 2, 3 or 4; 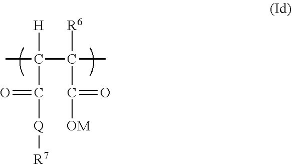
in which
R⁶ is H or an unbranched or branched C₁-C₄ alkyl group;
Q is NR⁷ or O;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂,
n is 1, 2, 3 or 4; and
each M independently of any other is H or a cation equivalent and/or
wherein the dispersant is a comb polymer comprising units having a polyether side chain having at least one structural unit of the general formulae (IIa), (IIb), (IIc) and/or (IId): 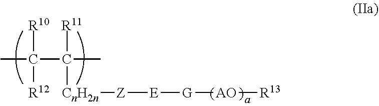
in which
R¹⁰, R¹¹ and R¹² independently of one another are H or an unbranched or branched C₁-C₄ alkyl group;
Z is O or S;
E is an unbranched or branched C₁-C₆ alkylene group, a cyclohexylene group, CH₂-C₆H₁₀, 1,2-phenylene, 1,3-phenylene or 1,4-phenylene;
G is O, NH or CO—NH; or
E and G together are a chemical bond;
A is CₓH₂ₓ with x=2, 3, 4 or 5, or is CH₂CH(C₆H₅);
n is 0, 1, 2, 3, 4 or 5;
a is an integer from 2 to 350;
R¹³ is H, an unbranched or branched C₁-C₄ alkyl group, CO—NH₂ and/or COCH₃; 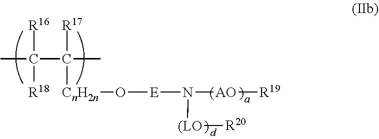
in which
R¹⁶, R¹⁷ and R¹⁸ independently of one another are H or an unbranched or branched C₁-C₄ alkyl group;
E is an unbranched or branched C₁-C₆ alkylene group, a cyclohexylene group, CH₂-C₆H₁₀, 1,2-phenylene, 1,3-phenylene, or 1,4-phenylene, or is a chemical bond;
A is CₓH₂ₓ with x=2, 3, 4 or 5, or is CH₂CH(C₆H₅);
n is 0, 1, 2, 3, 4 or 5;
L is CₓH₂ₓ with x=2, 3, 4 or 5, or is CH₂—CH(C₆H₅);
a is an integer from 2 to 350;
d is an integer from 1 to 350;
R¹⁹ is H or an unbranched or branched C₁-C₄ alkyl group;
R²⁰ is H or an unbranched C₁-C₄ alkyl group; 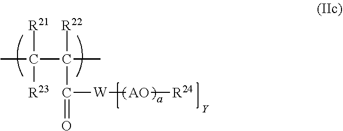
in which
R²¹, R²² and R²³ independently of one another are H or an unbranched or branched C₁-C₄ alkyl group;
W is O, NR²⁵, or is N;
Y is 1 if W=O or NR²⁵, and is 2 if W=N;
A is CₓH₂ₓ with x=2, 3, 4 or 5, or is CH₂CH (C₆H₅);
a is an integer from 2 to 350;
R²⁴ is H or an unbranched or branched C₁-C₄ alkyl group; and
R²⁵ is H or an unbranched or branched C₁-C₄ alkyl group; 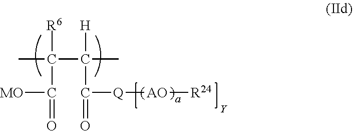
in which
R⁶ is H or an unbranched or branched C₁-C₄ alkyl group;
Q is NR¹⁰, N or O;
Y is 1 if W=O or NR¹⁰ and is 2 if W=N;
R¹⁰ is H or an unbranched or branched C₁-C₄ alkyl group; and
A is CₓH₂ₓ with x=2, 3, 4 or 5, or is CH₂C (C₆H₅)H;
R²⁴ is H or an unbranched or branched C₁-C₄ alkyl group;
M is H or a cation equivalent; and
a is an integer from 2 to 350.

23. The binder composition according to claim 16,
wherein the dispersant is a phosphorylated polycondensation product comprising structural units (III) and (IV): 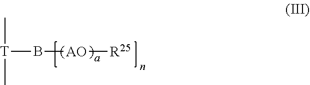
in which
T is a substituted or unsubstituted phenyl or naphthyl radical or a substituted or unsubstituted heteroaromatic radical having 5 to 10 ring atoms, of which 1 or 2 atoms are heteroatoms selected from N, O and S;
n is 1 or 2;
B is N, NH or O, with the proviso that n is 2 if B is N and with the proviso that n is 1 if B is NH or O;
A is an unbranched or branched alkylene with 2 to 5 carbon atoms or CH₂CH (C₆H₅);
a is an integer from 1 to 300;
R²⁵ is H, a branched or unbranched C₁ to C₁₀ alkyl radical, C₅ to C₈ cycloalkyl radical, aryl radical, or heteroaryl radical having 5 to 10 ring atoms, of which 1 or 2 atoms are heteroatoms selected from N, O and S;
where the structural unit (IV) is selected from the structural units (IVa) and (IVb): 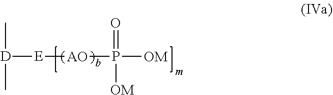
in which
D is a substituted or unsubstituted phenyl or naphthyl radical or a substituted or unsubstituted heteroaromatic radical having 5 to 10 ring atoms, of which 1 or 2 atoms are heteroatoms selected from N, O and S;
E is N, NH or O, with the proviso that m is 2 if E is N and with the proviso that m is 1 if E is NH or O;
A is an unbranched or branched alkylene with 2 to 5 carbon atoms or CH₂CH (C₆H₅);
b is an integer from 0 to 300;
M independently at each occurrence is H or a cation equivalent; 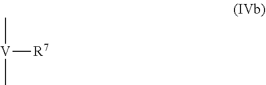
in which
V is a substituted or unsubstituted phenyl or naphthyl radical and is optionally substituted by 1 or two radicals selected from R⁸, OH, OR⁸, (CO)R⁸, COOM, COOR⁸, SO³R⁸ and NO₂;
R⁷ is COOM, OCH₂COOM, SO₃M or OPO₃M₂;
M is H or a cation equivalent; and
R⁸ is C₁-C₄ alkyl, phenyl, naphthyl, phenyl-C₁-C₄ alkyl or C₁-C₄ alkylphenyl.

24. The binder composition according to claim 16,
wherein the component F) comprises hydroxycarboxylic acid or the polycondensate of said hydroxycarboxylic acid or the sulfite addition product of said hydroxycarboxylic acid or citric acid or tartaric acid.

25. The binder composition according to claim 16,
wherein the component F) comprises a salt of formula (I) having the following moieties
R2 is H,
R3 is C₃-C₆ alkyl which may be substituted by 1 to 5 OH, and
R4 is COOY, and
Y is X being an alkali metal.

26. The binder composition according to claim 16, wherein the component F) comprises at least two compounds selected from the group consisting of a compound of formula (I) and a polycondensate of said compound of formula (I).

27. The binder composition according to claim 16,
wherein the binder composition further comprises
H) a supplementary cementitious material in an amount of from 0.5 to 68.989 wt.-%, based on the total weight of the binder composition, selected from the group consisting of slag, fly ash, natural pozzolans, calcinated clay, silica fume, limestone, and mixtures thereof.

28. A method comprising utilizing a retarding mixture (RM) comprising
RM1) a carbonate selected from the group consisting of organic carbonate, alkali carbonate, and mixtures thereof, in an amount of from 30 to 60 wt.-%;
RM2) NR¹R²R³ and/or metal salts thereof, wherein R¹ to R³ are independently C₁-C₆-hydroxyalkyl, in an amount of from 5 to 20 wt.-%;
RM3) R⁵—(CHOH)₀—R⁴ and/or metal salts thereof, wherein R⁴ and R⁵ are independently C₁-C₆-hydroxyalkyl, wherein o is an integer from 0-1, in an amount of from 10 to 30 wt.-%;
RM4) a component RM4) selected from the group consisting of a compound of formula (I), a polycondensate of said compound of formula (I), and mixtures thereof, wherein formula (I) is represented by 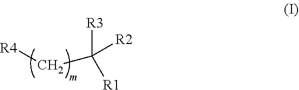
wherein
R1 is OH;
R2 is H, OH, C₁-C₆ alkoxy, —SO₂X, —SO₃X, —OSO₃X, —PO, —PO₃X₂, —OPO₃X₂, —Z—OOX or —CH(OH)—SO₃X;
R3 is H, COOX, C₃-C₆ alkyl which may be substituted by 1 to 6 OH or C₁-C₆ alkoxy;
m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and
Z is CH₂ or CH(OH), in an amount of from 12 to 50 wt.-%;
each based on the total weight of the retarding mixture (RM),
and a dispersant having a charge density of more than 0.80 μeq/g for improving the spread and/or the compressive strength of a construction material composition comprising Portland cement clinker, calcium sulfate, sodium sulfate, and optionally supplementary cementitious material.

29. A concrete comprising the binder composition according to claim 16.

30. A method comprising utilizing a retarding mixture (RM) comprising
RM1) a carbonate selected from the group consisting of organic carbonate, alkali carbonate, and mixtures thereof, in an amount of from 30 to 60 wt.-%;
RM2) NR¹R²R³ and/or metal salts thereof, wherein R¹ to R³ are independently C₁-C₆-hydroxyalkyl, in an amount of from 5 to 20 wt.-%;
RM3) R⁵—(CHOH)ₙ—R⁴ and/or metal salts thereof, wherein R⁴ and R⁵ are independently C₁-C₆-hydroxyalkyl, wherein o is an integer from 0-1, in an amount of from 10 to 30 wt.-%;
RM4) a component RM4) selected from the group consisting of a compound of formula (I), a polycondensate of said compound of formula (I), and mixtures thereof, wherein formula (I) is represented by 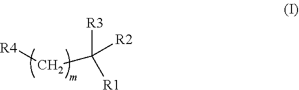
wherein
R1 is OH;
R2 is H, OH, C₁-C₆ alkoxy, —SO₂X, —SO₃X, —OSO₃X, —PO, —PO₃X₂, —OPO₃X₂, —Z—COOX or —CH(OH)—SO₃X;
R3 is H, COOX, C₃-C₆ alkyl which may be substituted by 1 to 6 OH or C₁-C₆ alkoxy;
m is 0 or 1; or
R1 and R2 taken together with the carbon atom to which they are attached form a carbonyl group provided m is 0;
R4 is COOY or SO₃X;
X is selected from H or a cation equivalent Kₐ wherein K is selected from an alkali metal, alkaline earth metal, zinc, iron, ammonium or phosphonium cation and a is 1/n wherein n is the valency of the cation;
Y=is selected from X, C₁-C₆ alkyl or phenyl; and
Z is CH₂ or CH(OH),
in an amount of from 12 to 50 wt.-%;
each based on the total weight of the retarding mixture (RM),
and a dispersant having a charge density of more than 0.80 μeq/g for retarding the hardening of inorganic binder containing building material formulations and/or for producing building products.
